(19) United States
(12) Patent Application Publication
(10) Pub. No.: US 2012/0278256 A1
(43) Pub. Date: Nov. 1, 2012

(54) METHOD AND APPARATUS FOR INVESTING IN CREDIT FACILITY AND FOR CALCULATING FEE DISTRIBUTIONS

(76) Inventor: Christopher J. Williams, New York, NY (US)

(21) Appl. No.: 13/455,938

(22) Filed: Apr. 25, 2012

Related U.S. Application Data
(60) Provisional application No. 61/479,673, filed on Apr. 27, 2011.

(51) Int. Cl. G06Q 40/06

(52) U.S. Cl. 705/36 R

(57) ABSTRACT

Disclosed is a computer implemented system by which investors may allocate securities to a Fund where they are used as collateral for offers of credit given by the Fund to borrowers. The value of each investor's Segregated Securities relative to the total Fund value determines the investor's percentage ownership in the Fund. In exchange for offers of credit, the Fund receives incremental Credit Facility Fees, which are paid out to investors as dividends in proportion to their percentage of ownership. The portion of the investor's Segregated Securities committed as collateral to a credit commitment determines the investor's percentage of commitment in the Fund. The Segregated Securities of each investor are managed by the investor or a third party manager at the investor's direction, even while segregated. Therefore, the real-time cash value of the Fund, ownership percentage, and commitments of each investor can change and are calculated by a computer system.

### CROSS-REFERENCE TO RELATED APPLICATIONS

This application claims priority to U.S. Provisional Application Ser. No. 61/479,673 filed Apr. 27, 2011, the entire contents of which is hereby incorporated by reference herein.

### FIELD

This disclosure relates generally to a method and apparatus for investing in a credit facility with a potential for return on the investment, and more particularly to a method for investing through an investment entity or fund by offering a credit commitment to interested entities which are backed by investor commitments and by collecting fees for the offered credit.

### BACKGROUND

Revenue from contingent offers of credit, particularly to corporate borrowers, is typically reserved only for commercial banks and investment banks. Accordingly, there is a need for a method and apparatus to enable investors to gain access to sources of revenue from offers of credit to borrowers, such as corporate borrowers or potential borrowers.

### SUMMARY

The present invention provides a method and apparatus of investing in an investment entity, such as in a fund, by committing capital or other investments with a potential for incremental return on the investment. The investment entity functions as a credit facility, offering revolving credit to interested entities as potential borrowers, and as a result collects fees from the interested entities. The investors in the investment entity, who may be limited partners in an investment fund or other investment entity, receive at least a portion of the fees collected by the investment entity from the potential borrower. The investment entity or fund may perform other functions as well, providing additional income streams to the investors.

In an embodiment of the method, an investor allocates a portion of the investor's investment portfolio to the investment entity, for example as a commitment of specific securities or other investment instruments. The allocated portion of the investment portfolio serves to fund the contingent obligations of the investment entity, in part or in total. In one embodiment, the portion of the investment portfolio allocated to the investment entity or fund is a portfolio of the investor's securities, which are referred to as segregated securities. The segregated securities or other investment instruments of the investor's portfolio support the contingent obligations of the investment entity, in return for which the investor receives a share of credit facility fee revenue received by the investment entity. The investment entity is given the authority to liquidate the segregated securities or other investment instruments if needed, but in general the segregated securities are not liquidated until and unless the fund is in need of immediate cash funding when a potential borrower draws down on offered credit from the investment entity. It is desirable that the segregated securities be cash equivalents such as U.S. Treasury Bonds, highly rated government agency bonds and high grade corporate bonds. Repos (or repurchase agreements) that are collateralized by the cash equivalents may also be utilized as the segregated securities. Other investments in the investor's portfolio are also possible.

The interested entities or potential borrowers that are being offered the revolving credit by the fund or investment entity are in one embodiment corporations or businesses or other entities selected by the investment entity. Preferably, the offer of credit is extended only to corporations having high credit ratings. The potential borrowers pay fees to the investment entity for the extended credit offer.

For the investor, such as a limited partner, in the investment entity or fund, the investor receives the credit facility fees that result from the offered credit to the interested entities. This can include the upfront fee for the commitment to extend credit, commitment fees, and any interest and fees that result from a draw down by the interested entities, who as a result of the draw down are actual borrowers.

The investment entity or fund may also own a broker-dealer. The investors will receive an indirect ownership interest in the broker-dealer and are therefore entitled to receive any revenue associated with the broker-dealer. The broker-dealer may solicit interests in the fund as well as provide credit analysis and other services. The broker-dealer may also enter into a services sharing agreement or referral agreement with other broker-dealers. Where the fund-owned broker-dealer performs services for another broker-dealer, an agreed percentage of the services fees may be paid to the investment entity or fund at intervals. The investor receives a share of the profits earned by the broker-dealer as a result of the investor's ownership interest. In addition, the investor may receive at least a portion of fees and revenue received by the investment entity or fund, which are the result of directed business, referral agreement, commission sharing agreement, or service sharing agreement. The fees associated may include, capital markets and/or investment banking fees, such as debt and equity underwriting fees, commercial paper, share repurchase agent services, mergers and acquisitions advisory fees, investment management fees, referral fees, commission or service sharing fees, and other types of fees as determined to be appropriate by the fund and/or broker-dealer. The directed business can included directed trading commissions and capital markets as well as other fees and payments.

### BRIEF DESCRIPTION OF THE DRAWINGS

The present invention is described in detail below with reference to the attached drawing figures, wherein:

FIG. 1 is a schematic representation of a simplified embodiment of the investment in an investment entity and an undrawn credit commitment, according to the method disclosed herein;

FIG. 2 is a table showing an example calculation of the percentage ownership interest for each of five investors in an investment entity, according to an embodiment of the method disclosed herein;

FIG. 3. is a table showing an example calculation to determine the amount of the Credit Facility Fee dividends to be paid to each of five investors based on each investor's percentage ownership interest in the Fund, according to an embodiment of the method disclosed herein;

FIG. 4 is a schematic representation of a simplified embodiment of the investment in an investment entity and the exercise of a draw down by a borrower on a credit commitment given by the investment entity, according to the method disclosed herein;

FIG. 5 is schematic representation of an embodiment of a computer system used in performing the method disclosed herein.

### DETAILED DESCRIPTION

While the present disclosure is capable of being embodied in various forms, for simplicity and illustrative purposes, the principles of the disclosure are described by referring to several embodiments thereof. It is understood, however, that the present disclosure is to be considered as an exemplification of the claimed subject matter, and is not intended to limit the appended claims to the specific embodiments illustrated. It will be apparent to one of ordinary skill in the art that the disclosure may be practiced without limitation to these specific details. In other instances, well-known methods and structures have not been described in detail so as not to unnecessarily obscure the present disclosure.

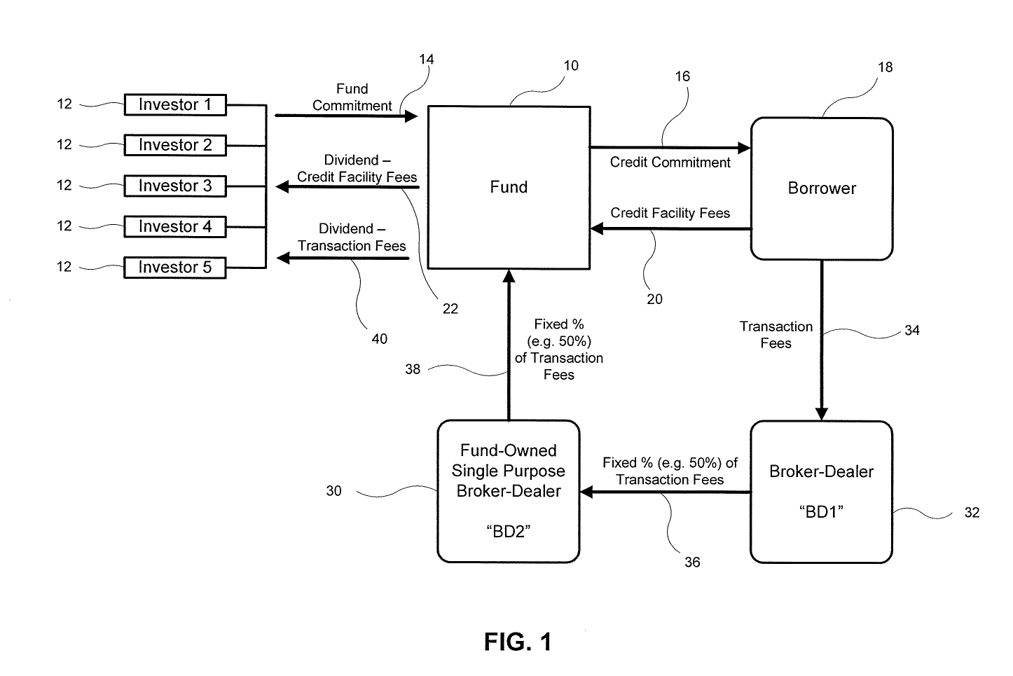

Referring to the embodiment of FIG. 1, in general, in the presently disclosed system and method, an investment entity or investment fund (hereafter “Fund”) 10 is established to act, at least in part, as a credit facility. In the embodiment of FIG. 1, the Fund 10 is established as a limited partnership. However the disclosure of such an embodiment should not be read to limit the scope of the form of the established Fund to being only that of a limited partnership. In alternate embodiments, the Fund may be established under other structures such as a sole proprietorship, a limited liability company, or other such structure. The Fund 10 enables investors 12, who may be limited partners in the Fund 10 or have other business relationships with the Fund 10, to invest in the Fund 10 by allocating investment instruments to the Fund 10 from the investor's own investment portfolio. To do so, each investor 12 commits to participation in the Fund 10 which includes segregating a specific amount of the investor's own existing investment instruments, such as public securities for example, into a separate account and pledging or committing 14 the segregated investment instruments, referred to as “Segregated Securities,” to the Fund 10. The investment instruments that are eligible to be used as the Segregated Securities can include at least publicly traded securities, cash equivalents (e.g. U.S. Treasuries, AAA-rated U.S. Government Agencies, high grade corporate bonds, etc.), repurchase agreements (“Repos”) collateralized by the aforementioned cash equivalents, and/or cash. Each investor transfers both the ownership and the liquidation authority of the Segregated Securities to the Fund 10, so that, if needed, the investment instruments that make up the Segregated Securities may be liquidated by the Fund and converted to cash.

While it is contemplated that cash may be used as an investment instrument in the Fund, the preferred embodiment does not require or include an actual investment of cash in the Fund 10. However, in alternate embodiments the investment of cash may be included as part, or all, of the investor's commitment of investment instruments in the Fund.

In a preferred embodiment, the Fund holds the Segregated Securities of one or more investors 12. The Segregated Securities that are committed to the Fund 10 by each respective investor 12 encompass each investor's total participation in the Fund 10. In return for the transfer of the Segregated Securities or other investments to the Fund 10, each investor receives a certain percentage of ownership interest in the Fund 10.

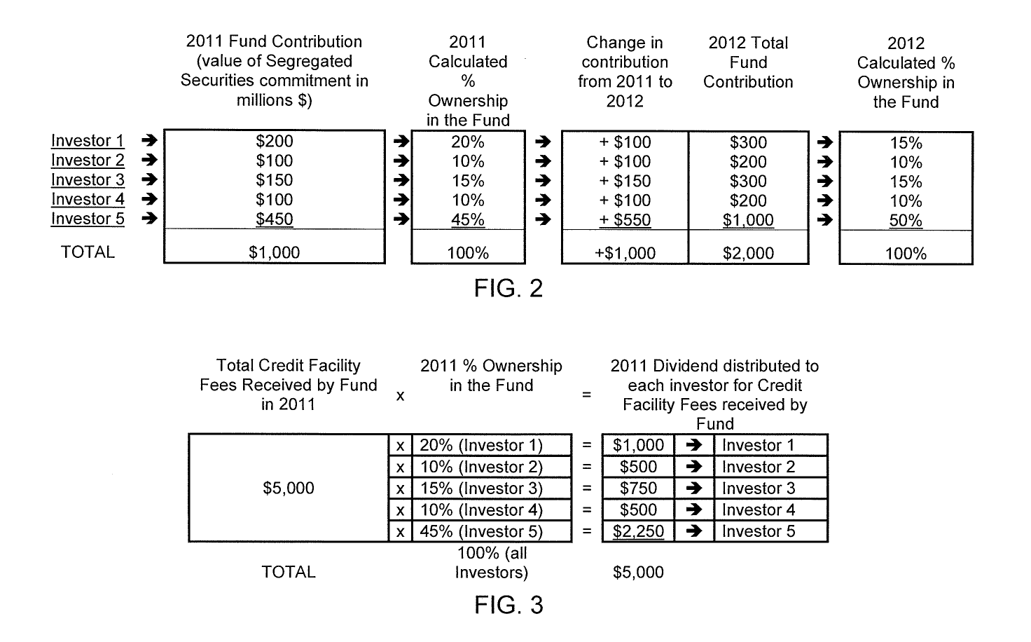

Referring to FIG. 2, in a preferred embodiment, the percentage ownership interest in the Fund 10 for each investor 12 is calculated by dividing the cash value of each investor's Segregated Securities commitment to the Fund 10 by the cash value of the Fund's total holdings from all investors. This calculation is performed by a computer system executing software to perform the ownership calculation and to calculate changes in ownership interest. The percentage of ownership interest for a given investor 12 may fluctuate if that investor, or another investor, either increases or decreases their commitment to the Fund 10, which would entail increasing or decreasing the number or value of the investment instruments in their Segregated Securities committed to the Fund 10. Similarly, as the Segregated Securities that are committed to the Fund change in value, the percentage ownership interest of each investor also changes and may be subject to a capital call. As is illustrated in the example shown in FIG. 2, a change in the fund contributions of each of the five investors from year 2011 to 2012, in which each investor increases their total contributions to the Fund by various amounts for year 2012, results in a corresponding change in the calculated % ownership in the Fund for each of the five Investors. In this example, the column labeled “Change in contribution from 2011 to 2012” can represent not only (1) adding new/additional investment instruments to (or removing them from) an investor's Segregated Securities portfolio in the Fund, but also (2) periodic changes in the values of each of the individual investment instruments that make up an investor's Segregated Securities portfolio, (3) changes in the value of the Segregated Securities portfolio due to substitution of one investment instrument in the portfolio with another investment instrument that is not yet a part of the Segregated Securities portfolio, or (4) any combination thereof.

During the time that the allocated investment instruments are part of the Segregated Securities owned by the Fund 10, each investor 12 may continue to manage his Segregated Securities, either directly or through third party investment managers, with virtually no restrictions with regard to trading or substituting eligible investment instruments in the investor's Segregated Securities portfolio. However, the investor's ability to continue to manage his Segregated Securities will come to an end at the point in time when the Segregated Securities are needed for liquidation by the Fund 10, the circumstances of which will be discussed in detail below. If the Segregated Securities are never needed for liquidation, they will be returned to the investor at the termination of the Fund as a credit facility. It is also possible that the Segregated Securities may be returned to the investors 12 at other times under various circumstances.

Separate from each investor's percentage ownership in the Fund, each investor's participation in the Fund 10 is identified by that investor's percentage of commitment in the total Fund 10, which in a preferred embodiment corresponds to the percentage of each investor's Segregated Securities that are committed to back the contingent obligation for the credit commitments made by the Fund 10 to the potential borrowers. The details of the Segregated Securities committed to the Fund 10 by the investors (e.g. type of each security committed by each investor, number of securities committed, real-time cash value of each security, total value of each investor's Segregated Securities portfolio, etc.), as well as the real-time percentage of ownership in the Fund 10, is tracked for each of the investors 12 by a computer system which runs one or more programs that are stored on tangible, non-transitory computer readable media, either on the computer or on an external storage device or server. The same or a different programmed computer system tracks, calculates, apportions and performs other calculations for other steps of the method disclosed herein. Additional details of the computer system will be discussed in further detail below.

The Fund 10 operates, at least in part, as a lender, by which the Fund 10 enters into one or more credit facilities through Credit Facility Agreements, or commitments of credit 16, with specific entities, such as corporations and other selected borrowers or potential borrowers 18. The value of the Segregated Securities being held as collateral to back the credit facilities must equal the value of the Fund's participation in credit facilities at all times. In one embodiment, since the investment instruments making up the Segregated Securities being held in the Fund are high quality, there is likely to be little fluctuation in the price of the Segregated Securities. In addition, investors are subject to overcollateralization guidelines, which should be enough to cover minimal movements in the price of the Segregated Securities. Calculations will be made daily by the computer system disclosed herein to ensure that the total value of the Segregated Securities is sufficient to back the committed credit facilities that have been entered into. If the value of the Segregated Securities is not sufficient to cover the committed credit facilities, the Fund will require the investors to pledge additional investment instruments to the Segregated Securities to cover the shortage.

In exchange for the offered credit commitment 16, the potential borrowers 18 each pay Credit Facility Fees 20 to the Fund 10. In one embodiment, the Credit Facility Fees 20 to be paid to the Fund 10 by each potential borrower may include, for example, one or more of a one-time upfront fee, a commitment fee, and drawdown and default interest, if applicable. In such an embodiment, each potential borrower negotiates for a specific rate(s) to be used by the Fund in calculating the amount of the upfront fee and commitment fee that is to be paid to the Fund. To arrive at the amount of the upfront and commitment fees, the negotiated rate is multiplied by the total amount of credit extended to the potential borrower by the lending Fund. The drawdown interest is calculated in a similar manner by multiplying the amount of credit extended to the borrower by a specific rate (e.g. Prime Rate, Fed Funds, LIBOR, etc.) plus a spread, which spread is tied to the credit quality/rating of the borrower. The worse the credit quality of the borrower, the larger the spread that is added. Default interest is owed, and must be paid by a borrower, when the borrower misses a Credit Facility Fee 20 payment. The amount of the default interest is typically an additional 1% to 2% of the amount of the missed Credit Facility Fee payment. While the above embodiments disclose specific fees to be included as Credit Facility Fees, as well as methods of calculating those Credit Facility Fees, such disclosure should not be read to limit the scope of what may be included as a Credit Facility Fee or the methods used to determine those Fees. Accordingly, in alternate embodiments, the Credit Facility Fees may be comprised of alternate, additional, or fewer fees, and alternate methods may be used to determine the fee amounts without departing from the scope of this disclosure. At least a percentage 22 of these Credit Facility Fees 20 generated by the Fund 10 are then paid out to the investors 12 as incremental fee income upon distribution of dividends from the Fund 10. The amount of the Credit Facility Fees paid to each investor is determined by each investor's percentage of ownership interest in the fund for a given period of time. The Credit Facility Fees received by the Fund and paid out to the investors are tracked by the computer system disclosed herein.

For example, FIG. 3 shows an embodiment of a calculation of the Credit Facility Fees to be paid to each investor as a dividend distribution for the year 2011. The total amount of the Credit Facility Fees Received by the Fund in 2011 (e.g. $5,000) is multiplied by each investor's percentage ownership in the Fund during that year. The resulting calculated amounts are the Credit Facility dividend amounts to be paid to each respective investor for 2011. This example calculation in FIG. 3 assumes that 100% of the Credit Facility Fees received by the Fund 10 are passed on to the investors. However, in alternate embodiments, 100% of the Credit Facility Fees, less specified Fund expenses, may be paid out to investors. In yet further embodiments, alternate methodologies may be used to calculate the Credit Facility Fees to be paid to investors, and the Fees may be paid out to investors as received by the Fund, rather than periodically as dividends.

This incremental fee income paid to investors 12 is an additional return on each of the investment instruments that make up the Segregated Securities of each investor 12, in excess of the regular investment returns generated for each investor 12 by the investment instruments themselves. The method disclosed herein benefits investors 12 by providing them with the ability to enhance their return on their existing investment instruments (e.g. fixed income and/or cash investment portfolios) by gaining unique access to incremental fee income that has been previously paid exclusively to commercial and investment banks. Accordingly, the investors 12 receive additional revenue to which they would not traditionally have access, and receive such revenue without having to (a) make any initial cash outlay, (b) participate in investment banking activities or other transaction based services, or (c) incur the operating risks that are traditionally associated with commercial banking, investment banking, or other similar businesses.

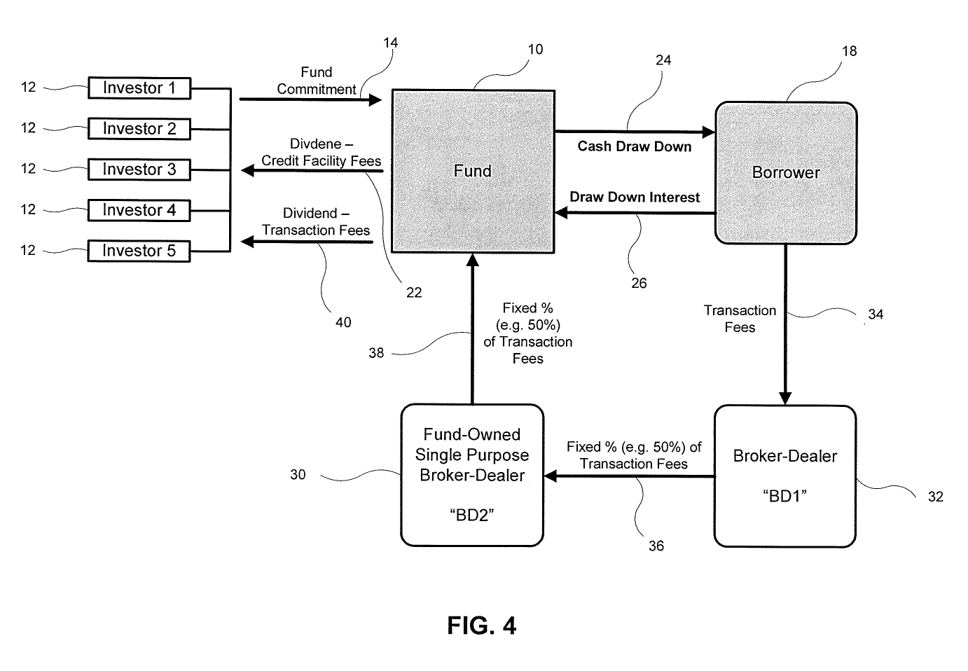

Referring to FIG. 4, if the potential borrower 18 entity decides to take a loan from the Fund 10 under the offered credit 16, referred to as a draw down 24, the Fund 10 will liquidate at least a part of each investor's Segregated Securities in order to generate the cash needed to fully fund the draw down 24 by the borrower 18. The cash generated by the liquidation is then lent to the borrower 18 under the pre-negotiated terms. The Segregated Securities of each investor 12 are liquidated for the draw down 24 in proportion to each investor's ownership interest in the Fund 10 multiplied by the Fund's draw down 24 obligation to the specific borrower 18 entity. In this way, the liquidated investment instruments of the Segregated Securities are used to satisfy the cash requirements of the Fund's Credit Facility commitments to the borrower 18. However, if any investors 12 do not want their securities liquidated to fund the draw down 24 by the borrower 18, those investors 12 have the option to fund their draw down obligation with cash. In addition, when a borrower 18 entity takes a draw down 24 on the committed offer of credit 16 from the Fund 10, additional Credit Facility fees in the form of draw down interest 26 and other revenue are paid to the Fund 10 by the borrower 18. At least a percentage of the draw down interest 26 is then paid to investors 12 in much the same manner as the other Credit Facility Fees discussed above.

In an alternate embodiment, it is contemplated that one or more individual investors 12 may enter into the Fund 10 using offshore/foreign securities and/or cash. In such an embodiment, a certain percentage, for example at least 1%, of the investor's segregated securities committed to the Fund must be domestically held securities and/or cash, while the remainder of the investor's commitment in the Fund may comprise offshore/foreign securities. The fees collected by the Fund are generally paid to the domestic investor/owner. If a drawdown occurs, the investor 12 has the option to fund the drawdown call by either (1) liquidating domestic securities and/or cash, (2) liquidated offshore/foreign securities, or (3) liquidate a combination of domestic and offshore/foreign securities and/or cash. However, if an investor 12 who commits to the Fund 10 with some offshore/foreign securities does not fund its drawdown commitment in a timely matter, the Fund 10 has the authority to liquidate either of the domestic securities and/or the offshore/foreign securities as needed, and in the case of the offshore/foreign securities, bring them back onshore to meet the drawdown call. If offshore/foreign securities are liquidated to fund the drawdown, the domestic investor 12 would lose the portion of its ownership interest in the Fund 10 that was comprised of the liquidated offshore/foreign securities. In this case, the offshore/foreign entity who held the liquidated offshore/foreign securities would then gain an ownership interest in the Fund 10, in proportion to the amount of the liquidated offshore/foreign securities as a percentage of the Fund's 10 total holdings, until the amount borrowed from the Fund 10 is paid back by the borrower 18. In this case, any fees received by the Fund 10 from the borrowing entity 18 would be paid to the offshore entity, as well as to whoever else has an ownership interest in the Fund 10, in proportion to their percentage of ownership interest in the Fund 10. One or more of the computer systems disclosed herein is configured to keep track of any and all changes in Fund ownership that may occur due to the commitment of offshore/foreign securities and/or cash to the Fund, as well as any required liquidation thereof.

Referring generally to FIGS. 1 and 2, the Fund 10 also establishes a Fund-owned single purpose broker-dealer entity 30, referred to herein for clarity as “BD2,” for the purpose of soliciting interest in the Fund 10 and providing credit reviews and analyses to the Fund 10. Thus, as the single purpose broker-dealer is established by the Fund, the investors 12 who have invested in a preferred embodiment of the Fund 10 also receive an indirect pro rata or proportionate ownership share in the single purpose broker-dealer entity 30, in addition to their ownership interest in the Fund 10. In addition to soliciting interest in the Fund and providing credit reviews and analyses, the single purpose broker-dealer 30 is able to enter into service sharing or referral agreements with other third-party broker-dealers, which may allow the Fund 10 to capture additional revenue streams, including those that might not traditionally be available to the Fund. In one embodiment, these revenue streams may include capital market transactions, referral fees, and/or administrative/service fees. Because the Fund 10 owns the single purpose broker-dealer 30, at least a portion of the revenue streams generated by the single purpose broker-dealer entity 30 is paid to the Fund 10, which in turn is paid to investors 12 who own the Fund 10.

For example, in one embodiment, the Fund-owned broker-dealer BD2 30 may enter into an agreement with an unrelated broker-dealer, referred to herein as “BD1” 32, by which BD1 agrees to provide certain broker-dealer services to the Fund's borrowers 18. The services that may be provided include various investment banking activities, such as for example, debt and equity underwriting, commercial paper, share repurchasing, investment management, and other such transactional services. BD1 will facilitate the service for the borrowers 18, and Fund-owned BD2 30 will perform a part of that service or transaction, such as certain administrative services.

Based on the services rendered by each broker-dealer, BD1 32 and BD2 30, the two broker-dealers 30 and 32 share the fees and revenue paid by the borrower 18 for the services that were provided. More specifically, the Fund may have access to a wide range of fees such as, credit facility fees, capital market fees, trading revenue, referral fees, administrative fees, service sharing fees, and other revenue or transaction fees (collectively “Transaction Fees” 34). The Fund-owned broker-dealer, BD2 30, receives at least a percentage 36 of the Transaction Fees 34 paid to BD1 32 by each borrower 18 or potential borrower. The Fund-owned broker-dealer, BD2 30, then passes on 38 those received Transaction Fees, less any administrative costs, to the Fund 10, which are then distributed to the investors 12 upon distribution of dividends 40 from the Fund 10 and in proportion to their percentage ownership in the Fund 10, just as is done with Credit Facility Fees. In one embodiment, a fixed percent of the Transaction Fees 34, for example 50%, is paid by BD1 to BD2. However, the scope of the percentage of Transaction Fees paid by BD1 to BD2 should not be limited to 50%. In alternate embodiments, alternate percentages may be paid and still be within the scope of this disclosure.

In addition to the above, any business directed by BD2 to BD1, or any services shared or performed by BD2 or BD1 will result in a portion of such fees, whether capital market/investment banking or administrative services or directed commissions, being paid to BD2, and will ultimately be paid out to the Fund investors 12 in a dividend distribution, less any administrative costs. It may be possible that a specific investor who directs business to BD1, which the gross revenue is ultimately shared by BD2 through a commission sharing arrangement, will receive at least a percentage of that revenue. The fees may also generally be shared with all the investors 12 in the Fund 10.

The computer system disclosed herein, or a different computer system, at least tracks the following: each investor's real-time commitment in the fund; each investor's real-time percentage ownership in both the Fund and the single-purpose broker-dealer BD2; each Credit Facility Agreement entered into by the Fund; each borrower or potential borrower; information regarding the revenues and fees that are generated, paid to the Fund, and distributed to the investors; the actual flow of all fees and revenues generated; and the Fund's total exposure to specific borrowers and to borrowers with various credit ratings. The information regarding revenues and fees tracked can include at least each Credit Facility Fee generated and which Credit Facility Agreement the fee is associated with, any draw down taken by a borrower, each investors' shares of each draw down, all transactions that generate Transaction Fees, the amounts of the Transaction Fees generated by each transaction, any additional fees generated, and other additional information, according to the method. Essentially, every transaction and payment made or received can be accounted for in the computer system, according to the method disclosed herein.

In addition, one or more computer systems perform all necessary calculations to execute the accurate accounting, liquidation, and income distribution functions of the Fund 10, according to the method. Furthermore, the computer system performs calculations to track the timing and expiration of the credit commitments made to each borrower. The input to the computer system and the output from the computer system may be automated and carried out by automatic means, including by electronic communication between the investors 12 the Fund 10 and the borrowers 18 that participate in the Fund 10. The functions may be performed automatically by the respective computer systems or steps of the process, such as data communication and entry, may be by manual entry of information received via electronic communications or other communications. In one example, the computer program running on the computer system is an Excel spreadsheet program sold by Microsoft, wherein the tracking and calculating functions are provided using the functions available in the spreadsheet and by formulas for performing the calculations that are embedded in the spreadsheet.

In one embodiment, not depicted in the drawing figures, the Fund engages a separate entity to act as a custody agent, which will set up and hold the Segregated Securities that are pledged to the Fund. The Segregated Securities owned by the Fund, which serve as collateral against the committed offers of credit, are monitored on a daily basis to ensure that, for each investor, the cash value of each investor's Segregated Securities is sufficient to cover the investor's proportionate share of the committed credit offers. The collateral in the form of the Segregated Securities will be monitored through a computer system maintained by the custody agent entity. This computer system may be accessed through a local network, or available to be accessed by authorized individuals through connection to the internet. The same, or an alternate, computer system is used to ensure the cash value of the Segregated Securities operating as collateral is sufficient to cover all credit commitments made by the Fund, calculate the ownership interest in both the Fund and a single purpose broker-dealer (the details of which are discussed below), as well as ensuring the Segregated Securities are liquidated to meet a draw down call. If such a draw down call occurs, the custody agent entity will liquidate at least a portion of the Segregated Securities on instructions from the Fund or the custody agent entity, whichever the case may be.

Alternately, the calculations may be performed by using a special purpose program, for example that is written specifically to perform the present method. As a result of the program, the computer that carries out the method becomes a special purpose computer used to perform the method. Additional functions may be incorporated into the computer system/program to perform calculations for each investor, for example. As appreciated by those of skill in the art, the examples set forth herein are but a few variations that are possible while encompassing the principles of the present method.

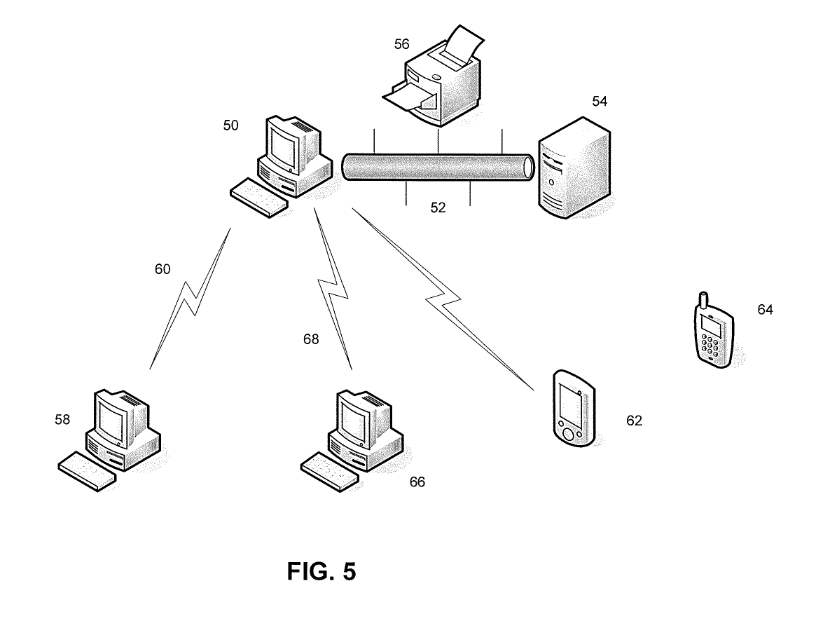

FIG. 5 shows an example of a computer system as used in the present method. The computer system includes a computer 50 that includes a processor, operating memory, a display, power supply and a user input in the form of a keyboard and potentially a pointing device such as a mouse. The computer 50 includes a tangible computer readable media, such as a hard drive, on which is stored a program that is executed by the processor to perform steps of the present method. The computer readable media also may store the data used in the method. The computer 50 may be a stand-alone computer 50 or it may be in communication with other computer devices and/or input/output devices. In the example, the computer 50 is connected by a communication network 52 to a server 54. The server 54 includes a hard drive as well or other computer readable media, on which may be stored the program that is executed by the computer 50 in the method and/or on which is stored data of the method. An output device 56, such as a printer, is also provided.

Input data for the method may be provided to the computer 50 in a variety of ways. For example, an investor may transmit data to the computer 50 and receive data from the computer 50 using an investor computer 58. The communication may be by wireless communication 60 or via wired communication. The investors may communicate with the computer 50 via a personal data device (PDA) 62 or via a telephone 64 or other communication or computer device. The investors can also communicate with company personnel that have access to the computer 50 so that, for example, data is communicated via telephone, email or other communication means and the data is input to or output from the computer 50 by the company personnel. The single investor computer 58 may represent a number of investor computers.

A borrower's computer 66 may be linked by a communication link 68 to the computer 50 to facilitate communications there between concerning the credit facility commitment, terms relating to the credit facility commitment, and any draw down or fees that are exchanged. The communication link 68 and all other communication links may be wireless or wired, and may result in automatic input and output of information or the input and output may be accomplished using a person to enter data received via the communication link 68 and retrieve data for transmittal via the communication link 68. The single borrower computer 66 may represent a number of borrower computers. Of course, other arrangements and configurations of computers and computer systems are possible and are encompassed within the present disclosure.

In FIGS. 1 and 4, simplified examples are set forth to illustrate the principles of the present disclosure. In one embodiment of the method disclosed herein and depicted in the diagram of FIG. 1, an undrawn credit commitment is shown wherein a number of limited partners as investors 12 provide a commitment 14 of Segregated Securities to the Fund 10, which in turn extends credit commitments 16 to a borrower 18. The borrower 18 pays Credit Facility Fees 20 to the Fund 10, which are then paid out 22 to the investors 12 upon distribution of dividends from the Fund 10. The borrower 18 may also pay additional revenues in the form of Transaction Fees 30 for broker-dealer services provided in relation to the borrower's participation in the Fund 10. The Transaction Fees 34 are paid or caused to be paid by the borrower 18 to a separate designated broker-dealer, BD1 32, who facilitated one part of the services provided, and a specified percentage 36 of the Transaction Fees 34 is paid to a Fund-owned broker-dealer 30, BD2, who performed another part of the services provided.

In FIG. 4, the borrower 18 takes a draw down 24 or loan against the committed offer of credit 16 given by the Fund 10. To fund the draw down, at least a portion of the Segregated Securities held by the Fund 10 are liquidated to cash, which is then paid to the borrower 18 in fulfillment of the draw down obligation. In return, the borrower 18 at least pays interest 32 on the loan that is received from the Fund 10. A proportionate divided distribution of the interest 32 is paid to the investors 12 in proportion to their ownership interest in the Fund 10.

Thus, there is shown and described a computer implemented invention by which investors may allocate or segregate securities to a Fund, where they are used as collateral for offers of credit given by the Fund to borrowers or potential borrowers. The value of each investor's Segregated Securities relative to the total value of the Fund determines the investor's percentage ownership interest in the Fund. In exchange for the offers of credit, the Fund receives incremental Credit Facility Fees, which are to be paid out to investors as dividends in proportion to their percentage of ownership in the Fund. The portion of the investor's Segregated Securities committed as collateral to a credit commitment determines the investor's percentage of commitment in the Fund. The Segregated Securities of each investor are being managed by the investor or a third party manager at the investor's direction, even while segregated. Therefore, the real-time cash value of the Fund, the ownership percentage, and the commitments of each investor is frequently changing and is calculated by the computer system. Upon draw down (a loan) by a borrower on the offer of credit, the Fund liquidates a portion of each investor's Segregated Securities, in proportion to each investor's percentage of ownership, to raise the cash needed to fund the draw down by the borrower. In exchange for the draw down, the Fund receives credit interest payments from the borrower that are passed to the investors as dividends in proportion to each investor's percent ownership interest.

Although other modifications and changes may be suggested by those skilled in the art, it is the intention of the inventors to embody within the patent warranted hereon all changes and modifications as reasonably and properly come within the scope of their contribution to the art.

What is claimed is:

1. A method for investing, comprising the steps of:
accepting allocations of investment instruments, including ownership and liquidation authority of said instruments, as contributions made to an investment entity from one or more investors;
tracking each investor's investment instrument contributions in the investment entity using a programmed computer device;
calculating each investor's contribution to the investment entity as a pro rata share, based on the respective investment instrument contributions of each investor as a percentage of the total investment instrument contributions accepted by the investment entity from all investors, using the programmed computer device;
committing offers of credit from the investment entity to selected potential borrowers;
tracking said committed offers of credit using the programmed computer device;
receiving credit facility fees resulting from said committed offers of credit to said potential borrowers;
calculating proportionate shares of the credit facility fees to be apportioned to each respective investor based on the calculated investor's interest in the investment entity; and
paying at least portions of the proportionate shares of said fees to said investors.

2. The method of claim 1, wherein said investment instruments are qualified securities.

3. The method of claim 2, wherein said qualified securities are cash equivalents.

4. The method of claim 1, wherein said selected borrowers are business entity borrowers.

5. The method of claim 1, wherein said step of receiving credit facility fees resulting from said committed offers of credit, includes receiving upfront commitment fees and annual participation fees in exchange for the investment entity's commitment of offers of credit to the potential borrowers.

6. The method of claim 1, wherein the step of calculating proportionate shares of the credit facility fees to be allocated to each respective investor includes multiplying each investor's calculated interest in the investment entity, as a percentage, by the credit facility fees received.

7. The method of claim 1, further comprising the steps of:
liquidating at least some of said accepted investment instruments upon draw down by a borrower on the offer of credit, in order to fund the draw down;
tracking said draw down using the programmed computer device;
receiving credit interest payments from said borrower;
calculating proportionate shares of said credit interest for each respective investor using the programmed computer device; and
paying the credit interest to the investors according to their calculated proportionate shares.

8. The method of claim 7, wherein the liquidating step includes liquidating the allocated investment instruments in proportion to each investor's interest in the fund multiplied by the fund's draw down obligation to a specific borrower.

9. The method of claim 7, wherein said step of calculating proportionate shares of said draw down interest includes multiplying each investor's calculated pro rata share, as a percentage, by the draw down interest received from the borrower.

10. The method of claim 7, further comprising the step of:
permitting said one or more investors to continue to manage the allocated investment instruments while they are allocated to the investment entity, until the investment instruments are needed for liquidation by the investment entity to fund a draw down by a borrower.

11. The method of claim 7, further comprising the steps of:
operating at least a part of said investment entity as a broker-dealer entity;
receiving broker-dealer revenue from said broker-dealer entity operation;
calculating proportionate shares of said broker-dealer revenue to be apportioned to each respective investor; and
paying the calculated proportionate shares of said broker-dealer revenue to the respective investors.

12. The method of claim 11, wherein said broker-dealer revenue includes at least capital market fees, trading revenue, and directed revenue paid by each borrower for business generated as a result of the borrower's participation in the investment entity.

13. The method of claim 11, further comprising the step of:
paying a referral fee to an investor for a referral of a borrower to the investment entity, which results in business activity that generates fees.

14. The method of claim 7, further comprising the steps of:
establishing a separate, single-purpose broker-dealer entity in connection with said investment entity;
receiving broker-dealer revenue from said broker-dealer entity operation;
calculating proportionate shares of said broker-dealer revenue to be apportioned to each respective investor, using said programmed computer device; and
paying said calculated proportionate shares of said broker-dealer revenue to said investors through said investment entity.

15. The method of claim 14, wherein said broker-dealer revenue includes at least capital market fees, trading revenue, and directed revenue paid by each borrower for business generated as a result of the borrower's participation in the investment entity.

16. The method of claim 14, further comprising the step of:
paying a referral fee to an investor for a referral of a borrower to either the investment entity or dealer-broker entity, which results in business activity that generates fees.

17. A method for investing, comprising the steps of:
accepting allocations of investment instruments as contributions from one or more investors;
tracking the allocated investment instruments as respective proportionate shares of investor contributions, based on the respective investment instrument contributions of each investor as a percentage of the total accepted investment instrument contributions of all investors, using a programmed computer device;
committing to offers of credit to selected borrowers;
tracking the credit offers using the programmed computer device;
receiving fees from said borrowers resulting from said offers of credit to said borrowers;
calculating proportionate shares of the fees for each respective investor;
paying at least portions of the proportionate shares of said fees to said investors;
liquidating at least some of said investment instruments of the investors upon borrower draw down on the offered credit commitment, in order to fund the drawdown;
tracking said draw down using the programmed computer device;
receiving draw down interest payments from said borrower;
calculating proportionate shares of the draw down interest for each respective investor using the programmed computer device; and
paying the calculated shares of the draw down interest to the investors.

18. A method as claimed in claim 17, further comprising the steps of:
operating as a brokerage;
receiving capital market fees from said brokerage operation;
calculating proportionate shares of the capital market fees of each respective investor; and
paying the calculated proportionate shares of the capital market fees to the respective investors.

19. The method of claim 17, wherein said investment instruments are qualified securities.

20. The method of claim 19, wherein said qualified securities are cash equivalents.

21. The method of claim 17, wherein said step of receiving fees from said offers of credit includes receiving upfront commitment of credit fees and annual participation fees.
